(19) United States
(12) Patent Application Publication
(10) Pub. No.: US 2023/0079569 A1
(43) Pub. Date: Mar. 16, 2023

(54) SOUND SOURCE SEPARATION APPARATUS, SOUND SOURCE SEPARATION METHOD, AND PROGRAM

(71) Applicant: NIPPON TELEGRAPH AND TELEPHONE CORPORATION, Tokyo (JP)

(72) Inventors: Shoichiro TAKEDA, Tokyo (JP); Kenta NIWA, Tokyo (JP); Shinya SHIMIZU, Tokyo (JP)

(73) Assignee: NIPPON TELEGRAPH AND TELEPHONE CORPORATION, Tokyo (JP)

(21) Appl. No.: 17/799,211

(22) PCT Filed: Feb. 13, 2020
(86) PCT No.: PCT/JP2020/005470

§ 371 Date: Aug. 11, 2022

(51) Int. Cl. G10L 21/028

(52) U.S. Cl. CPC G10L 21/028

(57) ABSTRACT

A sound source separation device (10) acquires, from a mixed signal including sounds that came from a plurality of sound sources, a separated signal including an emphasized sound for every sound source. A signal conversion unit (1) converts the mixed signal into the frequency domain. A separated signal estimation unit (2) acquires the separated signals from the mixed signal using an optimized filter. A gradient calculation unit (3) calculates the gradient of a cost function using the mixed signal and the separated signals. A filter update unit (4) optimizes the filter to fulfill separating, for every sound source, a sound emitted from the sound source, and to fulfill having, for every sound source, strong directivity in a direction of the sound source compared with a direction not of the sound source. A signal inverse conversion unit (5) converts the separated signals into the time domain.

### TECHNICAL FIELD

This invention relates to a sound source separation technology for separating a target sound source from a mixed signal composed of a plurality of mixed sound source signals.

### BACKGROUND ART

There is a technology called Independent Vector Analysis (IVA) that separates each target sound source from a mixed signal obtained by mixing a plurality of sound source signals that are acquired through a microphone in the real world (e.g., see NPL 1 and 2). This technology involves statistically dividing the mixed signal into independent separated signals in respective frequency bins, assuming the target sound sources are statistically independent from each other. These separated signals are obtained by a separation filter estimated within an optimization framework that uses a method such as maximum likelihood estimation being applied to the mixed signal. However, it is not guaranteed that the separated signals will be properly ordered throughout all the frequency bins, and the so-called permutation problem whereby separated signals are interchanged between frequency bins is known to often occur.

In order to solve this problem, many measures involve enhancing the estimation accuracy of the separation filter using space information of the sound source called the direction of arrival (DOA) (e.g., see NPL 3, 4, and 5). However, a problem with these technologies is that explicit procedures for utilizing the direction of arrival outside the optimization framework for estimating the separation filter are required, increasing the complexity of the algorithm.

### CITATION LIST

### Non Patent Literature

[NPL 1] Taesu Kim, Hagai T. Attias, Soo-Young Lee, Te-Won Lee, “Blind Source Separation Exploiting Higher-Order Frequency Dependencies,” IEEE Transactions on Audio, Speech and Language Processing, vol. 15, no. 1, January 2007.
[NPL 2] Francesco Nesta, Zbynek Koldovsky, “Supervised independent vector analysis through pilot dependent components,” IEEE International Conference on Acoustics, Speech and Signal Processing (ICASSP), 2017.
[NPL 3] Hiroshi Saruwatari, Toshiya Kawamura, Tsuyoki Nishikawa, Akinobu Lee, Kiyohiro Shikano, “Blind Source Separation Based on a Fast-Convergence Algorithm Combining ICA and Beamforming,” IEEE Transactions on Audio, Speech and Language Processing, vol. 14, no. 2, March 2006.
[NPL 4] Affan H. Khan, Maja Taseska, Emanuel A. P. Habets, “A Geometrically Constrained Independent Vector Analysis Algorithm for Online Source Extraction,” International Conference on Latent Variable Analysis and Signal Separation, vol. 9237, pp. 396-403, August 2015.
[NPL 5] Yuuki Tachioka, Tomohiro Narita, Jun Ishii, “Semi-Blind Source Separation using Binary Masking and Independent Vector Analysis,” IEEJ Transactions on Electrical and Electronic Engineering, vol. 10(1), January 2015.

### SUMMARY OF THE INVENTION

### Technical Problem

NPL 3, 4, and 5 advocate using the direction of arrival in order to enhance the estimation accuracy of the separation filter. However, the processing of these NPL is explicitly performed outside the optimization framework that is used for estimating the separation filter, adding to the complexity of the algorithm. Also, the processing of these NPL is not differentiable, and is thus difficult to apply directly to a model premised on the gradient method such as a deep neural network.

In view of the above technical problems, an object of this invention is to realize a sound source separation technology that enables simple optimization that takes both estimation of the separation filter and utilization of the direction of arrival into consideration at the same time.

### Means for Solving the Problem

In order to solve the above problem, a sound source separation device of one mode of this invention is a sound source separation device for acquiring, from a mixed signal including sounds that came from a plurality of sound sources, a separated signal including an emphasized sound for every sound source, the device including a separated signal estimation unit configured to acquire the separated signals from the mixed signal, using a separation filter optimized to fulfill separating, for every sound source, a sound emitted from the sound source, and to fulfill having, for every sound source, strong directivity in a direction of the sound source compared with a direction not of the sound source.

### Effects of the Invention

The sound source separation technology of this invention enables simple optimization that takes both estimation of the separation filter and utilization of the direction of arrival into consideration at the same time.

### BRIEF DESCRIPTION OF DRAWINGS

FIG. 1 is a diagram illustrating a functional configuration of a sound source separation device.

FIG. 2 is a diagram illustrating a processing procedure of a sound source separation method.

FIG. 3 is a diagram illustrating a functional configuration of a computer.

### DESCRIPTION OF EMBODIMENTS

Hereinafter, embodiments of this invention will be described in detail. Note that the same reference numerals are given to constituent elements having the same function in the drawings, and redundant description will be omitted.

### Embodiments

Embodiments of this invention are a sound source separation device and method for executing an audio processing algorithm for separating each target sound source from a mixed signal composed of a plurality of mixed sound source signals. This audio processing algorithm includes (1) a signal conversion step of converting a mixed signal that is defined in the time domain into a mixed signal of the frequency domain, (2) a separated signal estimation step of estimating a separated signal of the frequency domain at a present time k, by applying a separation filter that is estimated at the present time k to the mixed signal of the frequency domain derived in the signal conversion step, (3) a gradient calculation step of calculating respective gradients of the likelihood relating to the separation filter that is estimated at the present time k and regularization that is based on the direction of arrival, using the mixed signal of the frequency domain derived in the signal conversion step and the separated signal of the frequency domain derived in the separated signal estimation step, (4) a filter update step of updating the separation filter, using the gradients calculated in the gradient calculation step, and (5) a signal inverse conversion step of converting the separated signal of the frequency domain derived in the separated signal estimation step into a separated signal that is defined in the time domain.

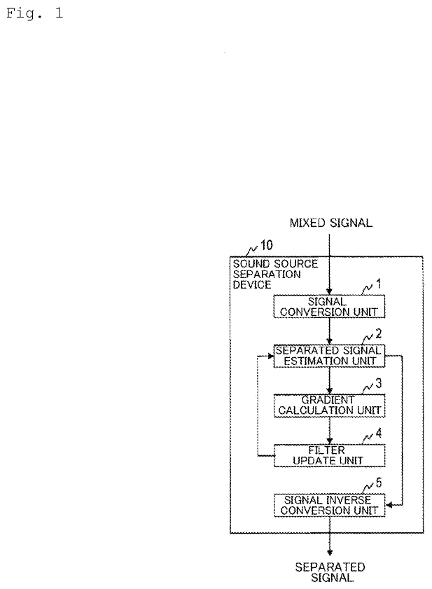

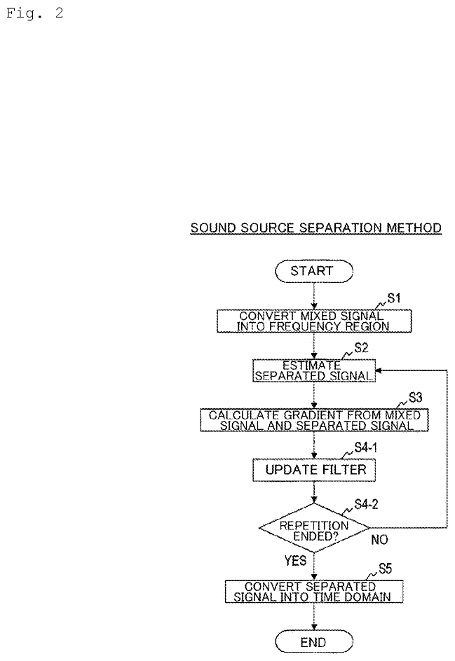

A sound source separation device 10 of an embodiment is an audio signal processing device that receives input of a mixed signal of the time domain that includes sounds that came from a plurality of sound sources, and outputs a separated signal of the time domain that includes an emphasized sound for every sound source. As illustrated in FIG. 1, the sound source separation device 10 is provided with a signal conversion unit 1, a separated signal estimation unit 2, a gradient calculation unit 3, a filter update unit 4, and a signal inverse conversion unit 5. The sound source separation method of an embodiment is realized by this sound source separation device 10 performing the processing of steps illustrated to FIG. 2.

The sound source separation device 10 is, for example, a special device constituted by a special program being loaded onto a known or dedicated computer having a Central Processing Unit (CPU) and a main storage device (Random Access Memory (RAM)), and the like. The sound source separation device 10 executes various processing under the control of the central processing unit, for example. Data input to the sound source separation device 10 and data obtained by the various processing is stored in the main storage device, for example, and data stored in the main storage device is read out to the central processing unit and utilized in other processing as required. The processing units of the sound source separation device 10 may be constituted at least in part by hardware such as an integrated circuit.

The processing procedure of the sound source separation method that is executed by the sound source separation device 10 of an embodiment will be described, with reference to FIG. 2.

In this embodiment, the number N of sound sources and the number M of microphones are known. Also, the input of the sound source separation device 10 is a mixed signal XₜₘεR of the time domain that is acquired from an m∈{1, . . . , M}th microphone. Here, t∈{1, . . . , T} represents each time frame, and T represents the maximum time frame. Also, R is the entire set of real numbers.

In step S1, the signal conversion unit 1 converts the mixed signal Xₜₘ of the time domain input to the sound source separation device 10 into a mixed signal x_{ftm}∈C of the frequency domain, using the Short-Time Fourier Transform (STFT) or the like. Here, f∈{1, . . . , F} represents each frequency bin, and F represents the maximum frequency bin. Also, C is the entire set of complex numbers. The signal conversion unit 1 outputs the mixed signal x_{ftm} of the frequency domain to the separated signal estimation unit 2 and the gradient calculation unit 3.

In step S2, the separated signal estimation unit 2, first, creates a separation matrix W_{f}^{(k)}=[w_{1f}^{(k)}, . . . , w_{Nf}^{(k)}]^{T}∈C^{N×M} whose rows contain a separation filter w_{nf}^{(k)}∈C^{1×M} that is estimated at the present time k. Note that ^{⋅T} represents transposition. Next, the separated signal estimation unit 2 estimates a separated signal y_{ftn}^{(k)} of the frequency domain at the present time k, by calculating the matrix product of the separation matrix W_{f}^{(k)} and a vector x_{ft}=[x_{ft1}, . . . , x_{ftm}]^{T}∈C^{M×1} of the mixed signal x_{ftm} of the frequency domain. Specifically, the separated signal estimation unit 2 calculates equation (1).

[Math. 1]

y_{ft}^{(k)}=W_{f}^{(k)}x_{ft} (1)

Here, y_{ft}^{(k)}=[y_{ft1}^{(k)}, . . . , y_{ftN}^{(k)}]^{T}∈C^{N×1}. The separation filter w_{nf}^{(k)} will output a separated signal y_{ftn}^{(k)} of the frequency domain that corresponds to an n∈{1, . . . , N}th sound source from the mixed signal vector x_{ft} of the frequency domain. The separated signal estimation unit 2 outputs the separated signal y_{ftn}^{(k)} of the frequency domain to the gradient calculation unit 3.

In step S3, the gradient calculation unit 3 calculates the gradient of the likelihood relating to the separation filter w_{nf}^{(k)} that is estimated at the present time k and the gradient of regularization that is based on the direction of arrival, using the mixed signal x_{ftm} of the frequency domain which is the output result of the signal conversion unit 1 and the separated signal y_{ftn}^{(k)} of the frequency domain which is the output result of the separated signal estimation unit 2. The gradient calculation unit 3 outputs the gradients to the filter update unit 4. Hereinafter, the method of calculating the gradients will be described in detail.

First, a negative log likelihood L_{NLL}^{(k)} at the present time k is defined as in equation (2) in relation to the mixed signal vector xₜₘ=[x₁ₜₘ, . . . , x_{Ftm}]^{T} that collects the mixed signal x_{ftm} of the frequency domain in the dimension of the frequency bin.

$$\begin{matrix}[ Math . 2 ] & \\ {L}_{NLL}^{( k )} = - log {\prod }_{t = 1}^{T} p ( {[ {x}_{t 1} , … , {x}_{tM} ]}^{T} \vert {\{ {W}_{f}^{( k )} \}}_{f = 1}^{F} ) & ( 2 )\end{matrix}$$

Equation (2) can be written as in equation (3), taking the linear constraint equation (1) into consideration.

$$\begin{matrix}[ Math . 3 ] & \\ {L}_{NLL}^{( k )} = {\sum }_{t = 1}^{T} {\sum }_{n = 1}^{N} - log ( p ( {y}_{tn}^{( k )} ) ) - 2 T {\sum }_{f = 1}^{F} log \vert det ( {W}_{f}^{( k )} ) \vert & ( 3 )\end{matrix}$$

Here, yₜₙ^{(k)} represents a separated signal vector [y₁ₜₘ^{(k)}, . . . , y_{Ftn}^{(k)}]∈C^{F×1} that collects the separated signal y_{ftn}^{(k)} of the frequency domain in the dimension of the frequency bin. p(yₜₙ^{(k)}) represents a stochastic model to which the separated signal vector yₜₙ^{(k)} conforms. Note that the stochastic model that is used here is generally the independent Laplacian distribution model (e.g., see NPL 1) or the like, although there is no particular restriction to the model in the present invention.

The gradient of the likelihood relating to the separation filter w_{nf}^{(k)}∈W_{f}^{(k)} that is estimated at the present time k is derived, by calculating the gradient of a complex conjugate W_{f}* of the separation filter with respect to equation (3). Specifically, the gradient calculation unit 3 calculates equation (4).

$$\begin{matrix}[ Math . 3 ] & \\ \frac{\partial {L}_{NLL}^{( k )}}{\partial {W}_{f}^{*}} = - \frac{1}{2} {( {W}_{f}^{( k )} )}^{- H} + E [ - \frac{\partial log ( p ( {y}_{tn}^{( k )} ) )}{\partial {y}^{*}} {x}_{ft}^{H} ] & ( 4 )\end{matrix}$$

Here, E[⋅] represents calculating the expected value of ⋅, and ^{⋅H} represents the Hermitian transpose.

Regularization that is based on the direction of arrival with respect to the separation filter w_{nf}^{(k)}∈W_{f}^{(k)} that is estimated at the present time k is also considered, and the gradient thereof is calculated. Here, regularization is defined as the composite function of simple functions g₁ to g₅, as in equation (5).

[Math. 5]

Lₙₒᵣₘ^{(k)}=g₁∘g₂∘g₃∘g₄∘g₅)({W_{f}^{(k)}}_{f=1}^{F}) (5)

Here, g₁ to g₅ are defined as follows.

$$\begin{matrix}[ Math . 6 ] & \\ {g}_{1} ( {h}_{1} ) = {‖ {h}_{1} ‖}_{2}^{2} & ( 6 )\end{matrix}$$

$${h}_{1} = {g}_{2} ( {h}_{2 , θ} ) = {max}_{θ} {\{ {h}_{2 , θ} \}}_{θ = 1}^{Θ} \qquad ( 7 )$$

$${h}_{2 , θ} = {g}_{3} ( {ψ}_{θ f} ) = \frac{1}{F} {\sum }_{f = 1}^{F} {ψ}_{θ f} \qquad ( 8 )$$

$${ψ}_{θ f} = {g}_{4} ( {\hat{W}}_{f} ) = \vert {\hat{W}}_{f} {a}_{θ f} \vert = \sqrt{{\hat{W}}_{f} {a}_{θ f} ⊙ {( {\hat{W}}_{f} {a}_{θ f} )}^{*}} \qquad ( 9 )$$

$${\hat{W}}_{f} = {g}_{5} ( {W}_{f}^{( k )} ) = {B}_{f} {W}_{f}^{( k )} \qquad ( 10 )$$

Here, ψ_{θf}=[ψ_{1θf}, . . . , ψ_{Nθf}]^{T} represents a beam pattern relating to the direction of arrival θ={1, . . . , θ} in a frequency bin f of the separation filter w_{nf}^{(k)}∈W_{f}^{(k)}. a_{θf}=[a_{1θf}, . . . , a_{Mθf}]^{T} represents an array manifold vector assuming the target sound source came from the direction of arrival θ by plane wave. B_{f}=diag [b₁, . . . , bₙ] is a scaling matrix for adjusting the problem whereby the scale for the separation matrix W_{f}^{(k)} is indeterminate during optimization, and a projection back technique (Reference Literature 1) for example, has been proposed, although there is no particular restriction to the technique in the present invention.

Also,

⊙ [Math. 7]

represents the Hadamard product, and ⋅* represents a complex conjugate.
[Reference Literature 1] D. E. Rumelhart, G. E. Hinton, R. J. Williams, et al., “Learning representations by back-propagating errors,” Cognitive Modeling, vol. 5, no. 3, pp. 1, 1988.

The beam pattern at the present time k is calculated by g₃◯g₄◯g₅ within this regularization. The beam pattern is a feature amount that can be rendered as a two-dimensional heat map (e.g., red is sensitivity high, blue is sensitivity low) with the direction of arrival θ on the x-axis, the frequency bin f on the y-axis, and the sensitivity value ψ_{θf} on the z-axis, and represents the characteristics of the separation filter. The maximum sensitivity relating to a given specific direction of arrival θ is then acquired with the max function of g₂. In other words, this is equivalent to acquiring the direction of arrival θ at which the red band appears darkest in the y-axis direction on the heat map. Also, the direction in which the separation filter w_{nf}^{(k)}∈W_{f}^{(k)} at the present time k is to form the maximum sensitivity, that is, the direction of arrival of the target sound source will be estimated implicitly. Finally, the extent to which the maximum sensitivity can be formed in a given specific direction of arrival is calculated using g₁. Note that although g₁ simply takes the form of an L₂ norm, the value of the maximum sensitivity ultimately converges on 1, and thus may conceivably be formulated as g₁=∥h₁−1∥₂². However, it is empirically clear that this makes regularization tougher and optimization unstable. Thus, it is basically desirable to use g₁=∥h₁∥₂² as in equation (6).

Since regularization Lₙₒᵣₘ^{(k)} is represented as a composite function of the simple functions g₁ to g₅, the gradient of regularization Lₙₒᵣₘ^{(k)} can be calculated as in equations (11) to (14), by using back propagation that is based on the chain rule used by neural networks and the like.

$$\begin{matrix}[ Math . 8 ] & \\ \frac{\partial {L}_{norm}^{( k )}}{\partial {W}_{f}^{⋆}} = \frac{\partial ( {g}_{1} \cdot {g}_{2} \cdot {g}_{3} \cdot {g}_{4} \cdot {g}_{5} ) ( {\{ {W}_{f}^{( k )} \}}_{f = 1}^{F} )}{\partial {W}_{f}^{*}} & ( 11 )\end{matrix}$$

$$= \frac{\partial {g}_{1} ( {h}_{1} )}{\partial {h}_{1}} \frac{\partial {h}_{1}}{\partial {h}_{2 , θ}} \frac{\partial {h}_{2 , θ}}{\partial {ψ}_{θ f}} \frac{\partial {ψ}_{θ f}}{\partial {\hat{W}}_{f}^{*}} \frac{\partial {\hat{W}}_{f}^{*}}{\partial {W}_{f}^{*}} \qquad ( 12 )$$

$$= {max}_{θ} ( \frac{1}{F} {\sum }_{f = 1}^{F} {ψ}_{θ f} ) ( {ψ}_{θ f}^{- 1} {\hat{W}}_{f} {a}_{θ f} {a}_{θ f}^{H} {B}_{f}^{H} ) \qquad ( 13 )$$

$$\approx {max}_{θ} ( \frac{1}{{f}_{2} - {f}_{1}} {\sum }_{f = {f}_{1}}^{{f}_{2}} {ψ}_{θ f} ) ( {ψ}_{θ f}^{- 1} {\hat{W}}_{f} {a}_{θ f} {a}_{θ f}^{H} {B}_{f}^{H} ) \qquad ( 14 )$$

Here,

II [Math. 9]

The outline character I is an indicator function, and represents propagating only the calculation result relating to the maximum direction of arrival \hat{ }θ=argmax_{θ}{h_{2,θ}}_{θ=1}^{θ} as the gradient. f₁ and f₂ are predetermined frequencies.

Also, in the present invention, equation (14) is proposed as an approximation of ∂Lₙₒᵣₘ^{(k)}/∂W_{f}*. This enables the frequency qualities of the target sound source to be incorporated when calculating the gradients. For example, since the main frequency band of the human voice is 500 to 3000 Hz, it is possible to calculate the gradients with consideration for only this frequency band by setting f₁=500 and f₂=3000.

Ultimately, a gradient ∂L^{(k)}/∂W_{f}* at the present time k is represented as in equation (15), as the weighted linear summation of the gradient ∂L_{NLL}^{(k)}/∂W_{f}* of the negative log likelihood and the gradient ∂Lₙₒᵣₘ^{(k)}/∂W_{f}* of regularization that is based on the direction of arrival.

$$\begin{matrix}[ Math . 10 ] & \\ \frac{\partial {L}^{( k )}}{\partial {W}_{f}^{*}} = \frac{\partial {L}_{NLL}^{( k )}}{\partial {W}_{f}^{*}} + γ \frac{\partial {L}_{norm}^{( k )}}{\partial {W}_{f}^{*}} & ( 15 )\end{matrix}$$

Here, γ is a weight hyperparameter. Accordingly, a cost function L^{(k)} at the present time k is defined by equation (16) from equations (3) and (5).

$$\begin{matrix}[ Math . 11 ] & \\ {L}^{( k )} = {\sum }_{t = 1}^{T} {\sum }_{n = 1}^{N} - log ( p ( {y}_{tn}^{( k )} ) ) - 2 T {\sum }_{f = 1}^{F} log \vert det ( {W}_{f}^{( k )} ) \vert - γ ( {g}_{1} \cdot {g}_{2} \cdot {g}_{3} \cdot {g}_{4} \cdot {g}_{5} ) ( {\{ {W}_{f}^{( k )} \}}_{f = 1}^{F} ) & ( 16 )\end{matrix}$$

In step S4-1, the filter update unit 4 updates a separation filter W_{f}^{(k)} at the present time k using the natural gradient method as in equation (17), for example, based on the gradient ∂L^{(k)}/∂W_{f}* at the present time k which is the output result of the gradient calculation unit 3, and calculates a separation filter W_{f}^{(k+1)} at the next time k+1.

$$\begin{matrix}[ Math . 12 ] & \\ {W}_{f}^{( k + 1 )} = {W}_{f}^{( k )} - α \frac{\partial {L}^{( k )}}{\partial {W}_{f}^{*}} {( {W}_{f}^{( k )} )}^{H} {W}_{f}^{( k )} & ( 17 )\end{matrix}$$

Here, α represents the update step size. Ultimately, a separated signal y_{ftn}^{(k+1)} of the frequency domain which is the output result of the separated signal estimation unit 2 when the separation filter W_{f}^{(k+1)} is no longer updated will be an expression in the frequency domain of the target sound source to be derived. The filter update unit 4 outputs the separation filter W_{f}^{(k+1)} to the separated signal estimation unit 2.

In step S4-2, the filter update unit 4 determines whether updating of the separation filter is completed. If updating is completed, the processing advances to step S5. If updating is not completed, the processing returns to step S2. It may be determined that updating is completed when the amount by which the separation filter is updated falls below a predetermined value, or when the separation filter has been updated a predetermined number of times, for example.

In step S5, the signal inverse conversion unit 5 converts the separated signal y_{ftn}^{(k+1)} of the frequency domain which is the output result of the separated signal estimation unit 2 into a separated signal yₜₙ∈R of the time domain, using the inverse short-time Fourier transform. The signal inverse conversion unit 5 outputs the separated signal yₜₙ of the time domain as the output of the sound source separation device 10.

The present invention proposes differentiable regularization for implicitly incorporating utilization of the direction of arrival into optimization, and proposes a simple novel optimization technique that takes both estimation of the separation filter and utilization of the direction of arrival into consideration in the optimization framework at the same time. Also, the regularization term proposed by the present invention is differentiable, and thus can be readily incorporated as an error term in a model premised on the gradient method such as a deep neural network.

Although embodiments of the present invention are described above, the specific configurations are not limited to these embodiments, and design modification and so forth are naturally intended to be included in the invention as appropriate to the extent that they do not depart from the spirit of the invention. The various types of processing described in the embodiments may not only be executed chronologically in accordance with the written order but may also be executed parallelly or individually as required or according to the processing capacity of the device that executes the processing.

[Computer Program, Recording Medium]

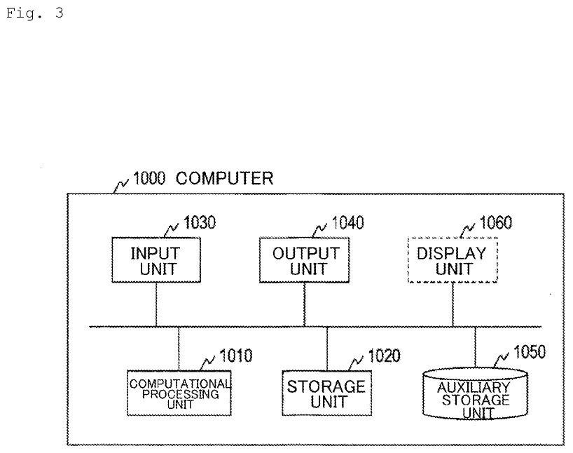

In the case where the various types of processing functions of the devices described with the above embodiments are realized by a computer, the processing contents of the functions that the devices are to be provided with are described by a computer program. The various types of processing functions of the above devices are realized on a computer, by causing this program to be loaded onto a storage unit 1020 of the computer shown in FIG. 3, and operating a computational processing unit 1010, an input unit 1030, an output unit 1040, and the like.

The program describing the processing contents can be recorded to a computer-readable recording medium. The computer-readable recording medium is, for example, a non-transitory recording medium, such as a magnetic recording device, an optical disc, and the like.

Also, distribution of this program is performed by, for example, selling, transferring, leasing and the like a portable recording medium such as a DVD and CD-ROM on which the program is recorded. Furthermore, a configuration may be adopted in which this program is distributed by storing the program on a storage device of a server computer, and transferring the stored program to other computers from the server computer via a network.

The computer that executes such a program first stores the program recorded on the portable recording medium or the program transferred from the server computer temporarily in an auxiliary recording unit 1050 which is a non-transitory storage device provided in the computer, for example. When processing is to be executed, this computer then loads the program stored in the auxiliary recording unit 1050 which is a non-transitory storage device provided in the computer onto the storage unit 1020 which is a transitory storage device, and executes processing that conforms to the loaded program. Also, as other execution modes of the program, the computer may be configured to load a program directly from the portable recording medium and execute processing that conforms to the loaded program, and may, furthermore, be configured such that, every time a program is transferred to the computer from the server computer, processing that conforms to the received program is executed. A configuration may also be adopted whereby a program is not transferred to the computer from the server computer, and the above-mentioned processing is executed by a so-called ASP (Application Service Provider) service that realizes processing functions through only execution instructions and result acquisition. Note that a program in this mode includes information provided for use in processing by an electronic computer and equivalent to a program (data, etc., that is not a direct instruction to the computer but has the characteristic of regulating processing by the computer).

Although, in this mode, the device is constituted by executing a predetermined program on a computer, at least some of the processing contents may be realized in a hardware manner.

1. A sound source separation device comprising a processor configured to execute a method comprising:
acquiring a separated signal from a mixed signal including sounds that came from a plurality of source sources, wherein the separated signal includes an emphasized sound for a sound source, using a separation filter optimized to:
fulfill separating, for a first sound source, a sound emitted from the first sound source, and
fulfill having, for the first sound source, strong directivity in a direction of the first sound source compared with a direction not of the first sound source.

2. The sound source signal separation device according to claim 1, wherein the separation filter is obtained by optimizing a likelihood of a target sound source and an index value that represents having strong directivity toward the sound source, based on a single cost function.

3. The sound source signal separation device according to claim 2, wherein the cost function is defined by the following equations, where
t={1, . . . , T} represents a time frame,
n={1, . . . , N} represents a sound source,
f={1, . . . , F} represents a frequency bin,
p(yₜₙ^{(k)}) is a stochastic model to which conforms a vector yₜₙ^{(k)} that collects a separated signal of a frequency domain in a dimension of the frequency bin,
W_{f}^{(k)} is a separation matrix whose rows contain a separation filter at a present time k,
γ is a weight hyperparameter, a_{θf} is an array manifold vector assuming the target sound source came from a direction of arrival θ={1, . . . , θ} by plane wave, and
B_{f} is a scaling matrix,
$$\begin{matrix}[ Math . 13 ] & \\ {\sum }_{t = 1}^{T} {\sum }_{n = 1}^{N} - log ( p ( {y}_{tn}^{( k )} ) ) - 2 T {\sum }_{f = 1}^{F} log \vert det ( {W}_{f}^{( k )} ) \vert - γ ( {g}_{1} \cdot {g}_{2} \cdot {g}_{3} \cdot {g}_{4} \cdot {g}_{5} ) ( {\{ {W}_{f}^{( k )} \}}_{f = 1}^{F} ) & \end{matrix}$$
$$with$$
$$\begin{matrix}[ Math . 14 ] & \\ {g}_{1} ( {h}_{1} ) = {‖ {h}_{1} ‖}_{2}^{2} \\ {h}_{1} = {g}_{2} ( {h}_{2 , θ} ) = {max}_{θ} {\{ {h}_{2 , θ} \}}_{θ = 1}^{Θ} \\ {h}_{2 , θ} = {g}_{3} ( {ψ}_{θ f} ) = \frac{1}{F} {\sum }_{f = 1}^{F} {ψ}_{θ f} \\ {ψ}_{θ f} = {g}_{4} ( {\hat{W}}_{f} ) = \vert {\hat{W}}_{f} {a}_{θ f} \vert \\ {\hat{W}}_{f} = {g}_{5} ( {W}_{f}^{( k )} ) = {B}_{f} {W}_{f}^{( k )} . & \end{matrix}$$

4. The sound source signal separation device according to claim 2, wherein the separation filter is optimized based on frequency characteristics of the sounds emitted from the sound sources.

5. The sound source signal separation device according to claim 4, wherein the separation filter is optimized by calculating the following equations, where
f₁ and f₂ are predetermined frequencies, the outline character I is an indicator function,
a_{θf} is an array manifold vector assuming the target sound source came from a direction of arrival θ by plane wave,
B_{f} is a scaling matrix, and
W_{f}^{(k)} is a separation matrix whose rows contain a separation filter at a present time k,
$$\begin{matrix}[ Math . 15 ] & \\ {max}_{θ} ( \frac{1}{{f}_{2} - {f}_{1}} {\sum }_{f = {f}_{1}}^{{f}_{2}} {ψ}_{θ f} ) ( {ψ}_{θ f}^{- 1} {\hat{W}}_{f} {a}_{θ f} {a}_{θ f}^{H} {B}_{f}^{H} ) & \end{matrix}$$
$$with$$
$$\begin{matrix}[ Math . 16 ] & \\ {ψ}_{θ f} = \vert {\hat{W}}_{f} {a}_{θ f} \vert \\ {\hat{W}}_{f} = {B}_{f} {W}_{f}^{( k )} . & \end{matrix}$$

6. A computer implemented method for acquiring sound source separation, the method comprising:
acquiring a separated signal from the mixed signal including sounds that came from a plurality of sound sources, using a separation filter optimized to:
fulfill separating, for a first sound source, a sound emitted from the first sound source, and
fulfill having, for the first sound source, strong directivity in a direction of the first sound source compared with a direction not of the first sound source, wherein the separated signal includes an emphasized sound for every sound source.

7. A computer-readable non-transitory recording medium storing computer-executable program instructions that when executed by a processor cause a computer to execute a method comprising:
acquiring a separated signal from the mixed signal including sounds that came from a plurality of sound sources, using a separation filter optimized to:
fulfill separating a sound emitted from a sound source of the plurality of sources, and
fulfill having strong directivity in a direction of the sound source compared with a direction not of the sound source, wherein the separated signal includes an emphasized sound for the sound source.

8. The sound source signal separation device according to claim 3, wherein the separation filter is optimized based on frequency characteristics of the sounds emitted from the sound sources.

9. The computer implemented method according to claim 6, wherein the separation filter is obtained by optimizing a likelihood of a target sound source and an index value that represents having strong directivity toward the sound source, based on a single cost function.

10. The computer implemented method according to claim 9, wherein the cost function is defined by the following equations, where
t={1, . . . , T} represents a time frame,
n={1, . . . , N} represents a sound source,
f={1, . . . , F} represents a frequency bin,
p(yₜₙ^{(k)}) is a stochastic model to which conforms a vector yₜₙ^{(k)} that collects a separated signal of a frequency domain in a dimension of the frequency bin,
W_{f}^{(k)} is a separation matrix whose rows contain a separation filter at a present time k,
γ is a weight hyperparameter, a_{θf} is an array manifold vector assuming the target sound source came from a direction of arrival θ={1, . . . , θ} by plane wave, and
B_{f} is a scaling matrix,
$$\begin{matrix}[ Math . 13 ] & \\ {\sum }_{t = 1}^{T} {\sum }_{n = 1}^{N} - log ( p ( {y}_{tn}^{( k )} ) ) - 2 T {\sum }_{f = 1}^{F} log \vert det ( {W}_{f}^{( k )} ) \vert - γ ( {g}_{1} \cdot {g}_{2} \cdot {g}_{3} \cdot {g}_{4} \cdot {g}_{5} ) ( {\{ {W}_{f}^{( k )} \}}_{f = 1}^{F} ) & \end{matrix}$$
$$with$$
$$\begin{matrix}[ Math . 14 ] & \\ {g}_{1} ( {h}_{1} ) = {‖ {h}_{1} ‖}_{2}^{2} \\ {h}_{1} = {g}_{2} ( {h}_{2 , θ} ) = {max}_{θ} {\{ {h}_{2 , θ} \}}_{θ = 1}^{Θ} \\ {h}_{2 , θ} = {g}_{3} ( {ψ}_{θ f} ) = \frac{1}{F} {\sum }_{f = 1}^{F} {ψ}_{θ f} \\ {ψ}_{θ f} = {g}_{4} ( {\hat{W}}_{f} ) = \vert {\hat{W}}_{f} {a}_{θ f} \vert \\ {\hat{W}}_{f} = {g}_{5} ( {W}_{f}^{( k )} ) = {B}_{f} {W}_{f}^{( k )} . & \end{matrix}$$

11. The computer implemented method according to claim 9, wherein the separation filter is optimized based on frequency characteristics of the sounds emitted from the sound sources.

12. The computer implemented method according to claim 10, wherein the separation filter is optimized based on frequency characteristics of the sounds emitted from the sound sources.

13. The computer implemented method according to claim 11, wherein the separation filter is optimized by calculating the following equations, where
f₁ and f₂ are predetermined frequencies, the outline character I is an indicator function,
a_{θf} is an array manifold vector assuming the target sound source came from a direction of arrival θ by plane wave,
B_{f} is a scaling matrix, and
W_{f}^{(k)} is a separation matrix whose rows contain a separation filter at a present time k,
$$\begin{matrix}[ Math . 15 ] & \\ {max}_{θ} ( \frac{1}{{f}_{2} - {f}_{1}} {\sum }_{f = {f}_{1}}^{{f}_{2}} {ψ}_{θ f} ) ( {ψ}_{θ f}^{- 1} {\hat{W}}_{f} {a}_{θ f} {a}_{θ f}^{H} {B}_{f}^{H} ) & \end{matrix}$$
$$with$$
$$\begin{matrix}[ Math . 16 ] & \\ {ψ}_{θ f} = \vert {\hat{W}}_{f} {a}_{θ f} \vert \\ {\hat{W}}_{f} = {B}_{f} {W}_{f}^{( k )} . & \end{matrix}$$

14. The computer-readable non-transitory recording medium according to claim 7, wherein the separation filter is obtained by optimizing a likelihood of a target sound source and an index value that represents having strong directivity toward the sound source, based on a single cost function.

15. The computer-readable non-transitory recording medium according to claim 14, wherein the cost function is defined by the following equations, where
t={1, . . . , T} represents a time frame,
n={1, . . . , N} represents a sound source,
f={1, . . . , F} represents a frequency bin,
p(yₜₙ^{(k)}) is a stochastic model to which conforms a vector yₜₙ^{(k)} that collects a separated signal of a frequency domain in a dimension of the frequency bin,
W_{f}^{(k)} is a separation matrix whose rows contain a separation filter at a present time k,
γ is a weight hyperparameter, a_{θf} is an array manifold vector assuming the target sound source came from a direction of arrival θ={1, . . . , θ} by plane wave, and
B_{f} is a scaling matrix,
$$\begin{matrix}[ Math . 13 ] & \\ {\sum }_{t = 1}^{T} {\sum }_{n = 1}^{N} - log ( p ( {y}_{tn}^{( k )} ) ) - 2 T {\sum }_{f = 1}^{F} log \vert det ( {W}_{f}^{( k )} ) \vert - γ ( {g}_{1} \cdot {g}_{2} \cdot {g}_{3} \cdot {g}_{4} \cdot {g}_{5} ) ( {\{ {W}_{f}^{( k )} \}}_{f = 1}^{F} ) & \end{matrix}$$
$$with$$
$$\begin{matrix}[ Math . 14 ] & \\ {g}_{1} ( {h}_{1} ) = {‖ {h}_{1} ‖}_{2}^{2} \\ {h}_{1} = {g}_{2} ( {h}_{2 , θ} ) = {max}_{θ} {\{ {h}_{2 , θ} \}}_{θ = 1}^{Θ} \\ {h}_{2 , θ} = {g}_{3} ( {ψ}_{θ f} ) = \frac{1}{F} {\sum }_{f = 1}^{F} {ψ}_{θ f} \\ {ψ}_{θ f} = {g}_{4} ( {\hat{W}}_{f} ) = \vert {\hat{W}}_{f} {a}_{θ f} \vert \\ {\hat{W}}_{f} = {g}_{5} ( {W}_{f}^{( k )} ) = {B}_{f} {W}_{f}^{( k )} . & \end{matrix}$$

16. The computer-readable non-transitory recording medium according to claim 14, wherein the separation filter is optimized based on frequency characteristics of the sounds emitted from the sound sources.

17. The computer-readable non-transitory recording medium according to claim 15, wherein the separation filter is optimized based on frequency characteristics of the sounds emitted from the sound sources.

18. The computer-readable non-transitory recording medium according to claim 16, wherein the separation filter is optimized by calculating the following equations, where
f₁ and f₂ are predetermined frequencies, the outline character I is an indicator function,
a_{θf} is an array manifold vector assuming the target sound source came from a direction of arrival θ by plane wave,
B_{f} is a scaling matrix, and
W_{f}^{(k)} is a separation matrix whose rows contain a separation filter at a present time k,
$$\begin{matrix}[ Math . 15 ] & \\ {max}_{θ} ( \frac{1}{{f}_{2} - {f}_{1}} {\sum }_{f = {f}_{1}}^{{f}_{2}} {ψ}_{θ f} ) ( {ψ}_{θ f}^{- 1} {\hat{W}}_{f} {a}_{θ f} {a}_{θ f}^{H} {B}_{f}^{H} ) & \end{matrix}$$
$$with$$
$$\begin{matrix}[ Math . 16 ] & \\ {ψ}_{θ f} = \vert {\hat{W}}_{f} {a}_{θ f} \vert \\ {\hat{W}}_{f} = {B}_{f} {W}_{f}^{( k )} . & \end{matrix}$$
